(19) United States
(12) Patent Application Publication
(10) Pub. No.: US 2009/0088059 A1
(43) Pub. Date: Apr. 2, 2009

(54) SAWING OF PIG CARCASSES OR THE LIKE

(75) Inventors: Christian Denis, Le Pouzin (FR); Maxence Gaydon, Montelimar (FR); Nicolas Klein, Loriol Sur Drome (FR)

Correspondence Address: HARNESS, DICKEY & PIERCE, P.L.C., P.O. BOX 828, BLOOMFIELD HILLS, MI, 48303, US

(73) Assignee: Durand International, Baix (FR)

(21) Appl. No.: 12/183,608

(22) Filed: Jul. 31, 2008

(30) Foreign Application Priority Data
Aug. 1, 2007 (FR) 0705609

(51) Int. Cl. A22B 5/20

(52) U.S. Cl. 452/160

(57) ABSTRACT

A method of sawing a pig carcass or the like, in which the starting point is a situation where a circular saw blade, carried by a saw head having a casing projecting from it at the front and downwards, is placed opposite and away from the top extreme part, where the hams are situated, of a carcass ready to saw, suspended head down by the rear legs, and then in a first step, the saw blade is moved transversely with a respect to and in the direction of the carcass, and then between the hams, in a second step, the saw blade being driven in rotation, the axial relative position of the carcass with respect to the saw blade being controlled, the saw blade is moved downwards from its top extreme position as far as a bottom extreme position in order to saw the carcass in two, axially, in a third step, the sawing of the carcass being ended, the saw blade is moved transversely with respect to the carcass in order to move it away from it.

### CROSS REFERENCE TO RELATED APPLICATIONS

This application claims priority to French Application No. 0705609, filed Aug. 1, 2007, which is incorporated by reference herein.

### BACKGROUND AND SUMMARY

The invention relates to the sawing of pig carcasses or the like (for examples calves). It concerns more precisely a method of sawing a pig carcass or the like, a protection device specially intended for a saw blade itself especially intended to be integrated in a machine for sawing a pig carcass or the like and allowing the implementation of the method, a machine for sawing a pig carcass or the like comprising such a device and, finally, an installation for sawing pig carcasses or the like.

Various methods and machines for sawing pig carcasses are already known. In one embodiment, the machine comprises a circular saw blade. According to the design, either the carcass is fixed or it is driven in movement by a conveyor during the sawing operation. Either the machine is situated on only one side of the movement plane of the carcasses or it is situated on both sides. In the latter case, either the machine has two structurally distinct functional assemblies or they are secured together.

According to circumstances, either the carcass is sawn completely in order to produce two independent half carcasses or it is sawn only partially, the two parts obtained by sawing remaining associated with each other in a non-sawn part situated in the region of the spine (this cut is known by the expression “American cut”), or even at the middle of the back. An embodiment of a method and machine for sawing pig carcasses is described for example in the document EP-A-1 125 502.

In a known fashion, the carcasses ready to be sawn are suspended head down by the rear hind legs. At the start, the circular saw blade is placed on the ventral side of the carcass opposite and away from the top extreme part to be sawn where the hams are situated. A dorsal support device and a ventral support device provide a correct fixed relative positioning of the carcass to be sawn with respect to the saw blade.

In a first step, the saw blade being driven in rotation, the saw blade is moved transversely with respect to, and in the direction of, the carcass, and then between the hams. In a second step, the relative axial position of the carcass with respect to the saw blade being controlled, the saw blade is moved downwards, still driven in rotation, from its top extreme position as far as a bottom extreme position, in order to saw the carcass. According to circumstances, as indicated, the sawing is only partial (American cut) or on the contrary is total. In a third step, the sawing of the carcass being considered to be ended, the saw blade is moved transversely with respect to the carcass in order to move it away from it. The cycle that has just been described can then be repeated, once the saw blade and the other components of the machine have been returned to their original position and state, and a new non-sawn carcass brought into the machine.

The hams being the most valuable part of the carcasses, it is important that their integrity be preserved during sawing. However, this result is in fact impossible to achieve, since in the first step the saw blade—driven pivotally—is operative in the front part of its sawing cutting edge interfering with the hams.

The document FR-A-2 738 719 also describes a sawing method and machine. In this case, a part called a “guard” is provided, disposed in front of the cutting blade in a fixed relative position, so as to be interposed, at the end of the second step, between the cutting blade and the uncut part of the carcass. This guard does not preserve the hams and moreover this is not its function. Its function is in fact to provide an internal guidance of the carcass with respect to the cutting blade. It thus prevents any risk of accidental total splitting resulting from a pendular oscillating movement of the carcass that is difficult to control.

The invention aims to preserve the integrity of the hams of the carcass, in particular in the case of an American cut. To this end, and according to a first aspect, the invention proposes a method of sawing a pig carcass or the like, in which:

the starting point is a situation where a circular saw blade, carried by a saw head having a casing projecting from it at the front and downwards, is placed opposite and away from the top extreme part—where the hams are situated—of a carcass ready to saw, suspended head down by the rear legs, and then

in a first step, the saw blade is moved transversely with a respect to and in the direction of the carcass, and then between the hams,

in a second step, the saw blade being driven in rotation, the axial relative position of the carcass with respect to the saw blade being controlled, the saw blade is moved downwards from its top extreme position as far as a bottom extreme position in order to saw the carcass in two, axially,

in a third step, the sawing of the carcass being ended, the saw blade is moved transversely with respect to the carcass in order to move it away from it.

According to the invention:

in the first step, at the latest before the saw blade interferes with the carcass, the front part of the sawing cutting edge of the saw blade that might interfere with the hands is made inoperative,

while, in the second step, the part of the sawing cutting edge of the saw blade driven in rotation that is to provide the sawing of the carcass is made operative. This method preserves the integrity of the hams, whilst ensuring effective sawing of the carcass. According to a preferential embodiment, also in the first step, the saw blade is driven in rotation.

It must be understood that, throughout the part of the first step in which the saw blade could interfere with a carcass, the front part of its sawing cutting edge is made and kept inoperative. Whereas throughout the second step, the part of the sawing cutting edge of the saw blade intended to saw the carcass is operative. The passage of the sawing cutting edge of the saw blade from the inoperative situation to the operative situation occurs at the end of the first step or at the start of the second step or between the two steps.

In a preferential application, the saw blade is moved downwards from its top extreme position as far as a bottom extreme position while keeping a bottom extreme part of the carcass uncut (American cut). This uncut part may be longer or shorter, limited to the spine or extending as far as the middle part of the back.

According to one embodiment of the method, a movable device for protection of the sawing cutting edge of the saw blade is used, situated with respect to the latter either in an inactive position or in an active position. In the inactive situation, the protection device uncovers the active part of the sawing cutting edge of the saw blade that is to saw the carcass, which is thus operative. In the active situation, the protection device protects the part of the sawing cutting edge of the saw blade that could interfere with the hams, which is thus made inoperative in the protected part. Thus the hams are preserved, which means that they are not cut into in an undesired unwanted fashion by the cutting blade.

According to one embodiment, a certain prior separation of the hams is provided, using means suitable for this purpose. This operation is carried out manually or in an automated fashion by a suitable machine, incorporated in the carcass sawing installation. The protection device is functionally dependent on the movement of the saw head.

The method envisaged here can be the subject of two embodiments. In a first embodiment, a movable protection device situated on the saw head side, namely typically the ventral side of the carcass, is used. In this case, this protection device is made to pass from the inactive situation, namely retracted, to the active situation, namely non-retracted, and vice versa, by tilting about the rotation axis of the saw blade, the tilting travel being in this case around a quarter of a turn. In a first embodiment, the passage of the protection device from the retracted inactive situation to the non-retracted active situation responds to an external command given for this purpose to the protection device.

In a second embodiment, the passage of the protection device from the retracted inactive situation to the non-retracted active situation responds to the set of forces—in particular weight and friction—to which the protection device is subjected. In a second embodiment, a movable protection device situated on the opposite side to the saw head, namely typically the dorsal side of the carcass, is used. In this case, this protection device is made to pass from the inactive situation to the active situation, and vice versa, by sliding and/or tilting, the passage from one to the other responding to an external command given for this purpose to the protection device.

According to a second aspect, the invention proposes a protection device especially intended for a saw blade itself especially intended to be integrated in a machine for sawing a pork carcass or the like, for implementing the method that has just been described. This protection device can be the subject of two embodiments, intended respectively for implementing the two embodiments of the method.

In the first embodiment of the protection device, intended for implementing the first embodiment of the method, the protection device is carried by the saw head and situated on the same side of it. The protection device according to this first embodiment comprises, firstly, a movable flat piece, having a first protection part in the form of a sector of a circular ring able to come to be placed opposite the sawing cutting edge of the saw blade while protecting it without preventing the pivoting of the saw blade, and a second support part in the form of a flange extending radially and rigidly supporting the first part. This protection device comprises, secondly, a swivel, coaxial with the saw blade, carried by the casing of the saw head, on which there is mounted the second part of the piece opposite to the first, and around which the piece can tilt between two extreme end-of-travel positions corresponding to the retracted inactive situation and to the non-retracted active situation.

This protection device comprises, thirdly, a space provided in the saw head, able to receive the movable piece in the retracted inactive situation so that it is then substantially situated in this space, while, in the non-retracted active situation, it is substantially situated outside this space, the said space being provided with a slot for the movable piece to pass. This protection device lastly comprises means able to make the movable piece pass from its retracted inactive situation to its non-retracted active situation, and vice versa, when required.

According to one embodiment, the first part of the movable piece is placed in the immediate vicinity of the sawing cutting edge of the saw blade and its angular opening is between 45° and 90°, in particular around 60°. According to one embodiment, the second part of the movable piece is in the form of radii and is situated in the immediate vicinity of the opposite face of the saw blade, but without contact with it.

According to one embodiment, firstly the swivel and the movable piece are carried by the internal face of a door of the casing of the saw head, the said door being able to be closed and kept positively closed by removable closure means, in particular during operation, and secondly the saw blade is carried by the body of the casing on which the door is pivotally mounted.

According to one embodiment, the space provided in the saw head is produced between the body of the casing provided with the saw blade and the internal face of the door, the slot of the space being delimited on one side by the body of the casing and on the other side by the door.

According to one embodiment, the device also comprises means of axial guiding of the movable piece. These are in the form of two shoes, fixed respectively to the body of the casing and to the door, so as to guide the first part of the movable piece sliding over the free faces of the shoes, on each side, during its tilting movement. In addition, the removable closure means of the door of the casing are mounted on the guide shoes. The means able to make the movable piece pass from its retracted inactive situation to its non-retracted active situation, and vice versa, when required, can be the subject of two different implementations, for the respective use of two implementations of the method previously described in relation to the first embodiment.

In a first implementation, the means able to make the movable piece pass from its retracted inactive situation to its non-retracted active situation, and vice versa, when required, comprise means of manoeuvring the movable piece controlled by external control means. According to one execution, means of manoeuvring the movable piece are a cylinder mounted between the casing and the movable piece. This cylinder is mounted on the internal face of the door of the casing. According to one embodiment, the tilting travel of the movable piece between its two extreme positions is around a quarter of a turn.

According to one embodiment, in the non-retracted situation, the first part of the movable piece makes inoperative the top part and the front part of the sawing cutting edge of the saw blade, from the guide shoes, as far as approximately the distal end of the saw blade, situated substantially in the horizontal plane of its axis, which could interfere with the hams. In any event, it is a case of making inoperative at least the part of the sawing cutting edge of the saw blade that would be liable to cut one or both of the hams of the carcass.

In a second embodiment, the means able to make the movable piece pass from it retracted inactive situation to is non-retracted active situation, and vice versa, when required, are the set of forces—in particular weight, friction—to which the movable piece is subjected. In the second embodiment of the protection device, intended for implementing the second embodiment of the method, the protection device is situated on the opposite side to the saw head. The protection device according to this second embodiment comprises, firstly, a movable protection piece, in the form of a fork whose plane is disposed horizontally, comprising a housing passage in the form of a slot for the saw blade, able to come to be placed opposite the sawing cutting edge of the saw blade while protecting it without preventing the pivoting of the saw blade.

This protection device comprises, secondly, means of supporting the movable piece, in particular carried or associated with the dorsal support device of the sawing machine. This protection device comprises, thirdly, means able to make the movable protection piece in the form of a fork pass by sliding and/or tilting from its inactive situation to its active situation, and vice versa, when required. These means comprise manoeuvring means—cylinder, rack, gearing, etc—for the fork-shaped movable piece, controlled by external control means, forming part of the machine control means.

According to a third aspect, the invention proposes a machine for sawing a pig carcass or the like, intended for implementing the method of sawing a pig carcass or the like described previously. This sawing machine can be the subject of two embodiments, intended respectively for using the two embodiments of the protection method and device described previously.

Such a sawing machine comprises first of all:

means of supporting the pig carcasses,

a frame,

a circular saw blade, carried by a saw head having a casing, projecting from it at the front and downwards,

a dorsal support device and a ventral support device providing a correct fixed relative positioning of the carcass to be sawn with respect to the saw blade,

means supporting the saw head, means supporting the dorsal support device, means supporting the ventral support device,

means for the coordinated guidance and driving of the means supporting the pig carcasses, the circular saw blade, the dorsal support device and the ventral support device, in successive sawing cycles,

control means.

In the first embodiment of the sawing machine, intended for implementing the first embodiment of the method, by means of the first embodiment of the protection device, the machine comprises such a device for protecting the saw blade, this protection device being carried by the saw head, and situated on the same side as it. According to one implementation, the control means for the protection device form part of the control means of the machine itself. In the second embodiment of the sawing machine, intended for implementing the second embodiment of the method, by means of the second embodiment of the protection device, the machine comprises such a device for protecting the saw blade, this protection device being carried by or associated with the dorsal support device, on the opposite side to the saw head. In this case, the means of controlling the protection device form part of the means of controlling the sawing machine itself.

According to a fourth aspect, the invention proposes an installation for sawing pig carcasses or the like, comprising means of supporting and driving the carcasses, along which there is situated a sawing machine as described in relation to the third aspect of the invention. According to one embodiment, the invention comprises, upstream of the machine, means able to provide a certain prior separation of the hams.

### BRIEF DESCRIPTION OF THE DRAWINGS

The invention will be clearly understood from a reading of the following description of several embodiments and implementations, with reference to the following Figures:

FIG. 1—which corresponds to a first embodiment of the invention and a first implementation—is a side elevation view of a saw head with casing closed, forming part of a pig carcass sawing machine, this saw head incorporating a device for protecting the saw blade according to the invention, in the retracted situation in which the device makes operative the part of the sawing cutting edge of the saw blade driven in rotation that is to provide the sawing of the carcass;

FIG. 2 is a side elevation view, similar to FIG. 1, the protection device being in a non-retraced situation in which the device makes inoperative the front part of the sawing cutting edge of the saw blade, which could interfere with the hams;

FIG. 3 is a perspective view of the inside of the saw head with the casing open, the protection device being in the retracted situation;

FIG. 4 is a perspective view similar to FIG. 3, the protection device being in the retracted situation;

FIG. 5—which corresponds to a second embodiment of the invention—is a partial side elevation view of a machine for sawing a pig carcass (with schematic representation of the pig carcass) having on one side a saw head and on the other side a movable device protecting the sawing cutting edge of the saw blade, this device being in the retracted position in which it makes operative the part of the sawing cutting edge of the saw blade driven in rotation that is to provide the sawing of the carcass;

FIG. 6 is a side elevation view similar to FIG. 5, the protection device being in a non-retracted situation in which it makes inoperative the front part of the sawing cutting edge of the saw blade that could interfere with the hams; and

FIG. 7 is a perspective plan view to a larger scale corresponding to the retracted situation in FIG. 5.

### DETAILED DESCRIPTION

The description is given with reference to a machine “in situ”. It is with respect to such a machine “in situ” that the words “vertical”, “horizontal”, “top” and “bottom” must be understood. A pig carcass sawing machine for which a device 1 for protecting the saw blade 2 according to the invention is intended comprises first of all means 32 for supporting and driving the pig carcasses C so that these, disposed vertically, are driven horizontally, in a vertical movement plane. Though the invention applies especially to pig carcasses, it goes without saying that it can be transposed to carcasses of equivalent animals. This means animals, the sawing of which is carried out in a similar manner to that used for pigs.

The word “front” refers to what is close to or turned towards the movement plane. The word “rear” refers what is on the contrary distant from or turned in the opposite direction to the movement plane. The word “transverse” refers to what is disposed perpendicular or substantially perpendicular to the movement plane.

The means 32 of supporting and driving the carcasses C do not necessarily form an exclusive part of the machine but of the installation that includes them. Means 32 of supporting the carcasses C are for example a conveyor from which two-legged brackets are suspended at regular intervals, intended for the attachment of the carcasses C by the rear legs, head downwards. In this way a transfer line for the carcasses C is defined.

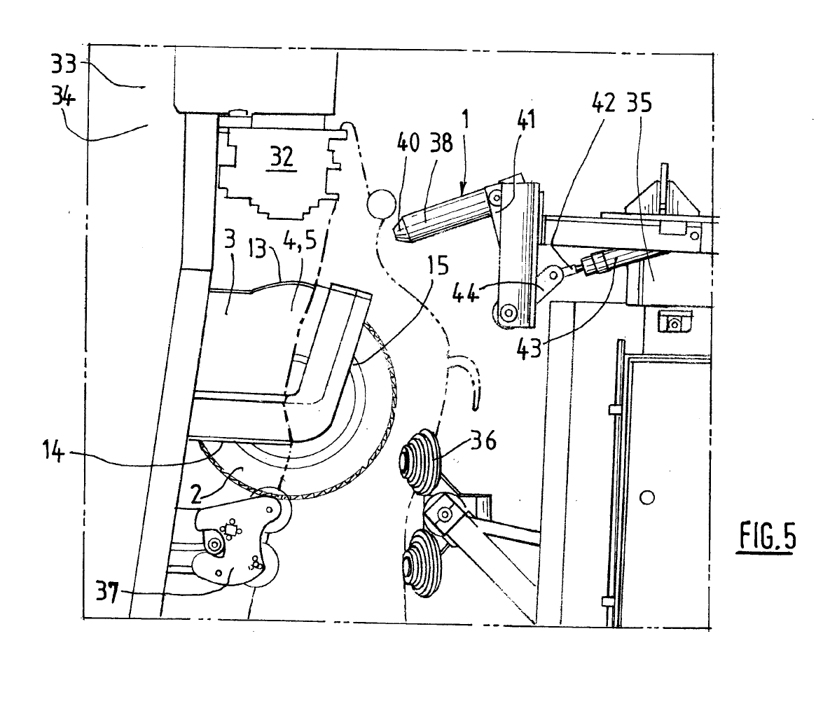

The machine proper (see FIGS. 5, 6 and 7) comprises a frame 33 which, according to the embodiment, is situated only on one side of the movement plane of the carcasses or on both sides. This frame 33 comprises in general a base resting on the floor and one or—in the case of FIGS. 5 to 7—two superstructures 34, 35 in the general form of a column. The frame 33, and more especially its superstructure or superstructures 34, 35, supports means supporting a saw head 3 including the saw blade 2, means supporting a dorsal support device 36 and means supporting a ventral support device 37. The ventral support device 36 and the dorsal support device 37, which form part of the sawing machine, are applied on each side of a carcass C. These various support means can be the subject of many different embodiments, according to the design of the machine.

Coordinated guidance and driving means are associated with it, suitable for the means 32 supporting the carcasses C, the circular saw blade 2, the dorsal support device 36 and the ventral support device 37 to move and function in successive sawing cycles able to ensure the vertical sawing of the carcasses gradually presented in the sawing machine. Naturally control means and programmable automatic controllers are provided. Equally, the machine comprises the appropriate safety means, adjustment means and cleaning means.

The circular saw blade 2, of axis 2a, and with a sawing cutting edge 2b, is carried by the saw head 3 which comprises a casing 4 having a casing body 5 and a casing door 6. The saw blade 2 is partly housed in the casing 4. It partly projects from the casing 4 at the front and downwards.

The casing 4 comprises a bulging rear part 7, intended to be fixed to the means supporting the saw head 3. The rear part 7 or the casing 4 is extended at the front and transversely by the casing body 5. The casing body 5 supports, close to its internal face 8, the circular saw blade 2. The face 8 is termed “internal” since, when the casing door 6 is closed, it is situated inside the casing 4. The casing door 6 is mounted so as to pivot on the casing body 5 towards the rear part 7, around hinges 9 of vertical or substantially vertical axis.

The saw head 3, the dorsal support device and the ventral support device are disposed transversely, in the same plane passing through the axis of the carcass to be sawn. The saw head and the ventral support device are situated on the same side of the movement plane (on the ventral side of the carcasses), the first above the second. The dorsal support device is situated on the other side of the movement plane (on the dorsal side of the carcasses), substantially level with the ventral support device.

The method of sawing a carcass used by such a sawing machine is as follows. In the starting situation a circular saw blade 2 is placed opposite and at a distance from the top extreme part to be sawn—where the hams are situated—of a carcass ready to be sawn, suspended head downwards by the rear legs. In a first step, the saw blade 2 being driven in rotation, the saw blade 2 is moved transversely with respect to, and in the direction of, the carcass, and then between the hams. In this first step, and at the latest before the saw blade 2 interferes with the carcass, the front part of the sawing cutting edge 2b of the saw blade 2 which could interfere with the hams is made inoperative. This way of proceeding preserves the integrity of the hams.

Such is therefore precisely the object of the protection device 1 with which the saw head 3 is equipped. This is because there is then no risk that the sawing cutting edge 2b of the saw will cut the ham or hams, and this because the protection device 1, then active and non-retracted, protects the part of the sawing cutting edge 2b that could cut them. The ventral and dorsal support devices respectively are used so that the carcass is in a coaxial relative position with respect to the saw blade 2, this position being kept fixed and therefore controlled.

In a second step, the relative axial position of the carcass with respect to the saw blade 2 being controlled, as has just been explained, the saw blade 2, still driven in rotation, is moved downwards from its top extreme position as far as a bottom extreme position in order to saw the carcass in two, axially. In this second step, the part of the sawing cutting edge 2b of the saw blade 2 driven in rotation that is to ensure the sawing of the carcass is made operative. The sawing of the carcass is therefore effective.

Finally, in a third step, the sawing of the carcass being considered to be ended, the saw blade 2 is moved transversely with respect to the carcass in order to move it away from it. The passage of the protection device 1 from the non-retracted active situation to the retracted inactive situation is demanded—and therefore the passage of the sawing cutting edge 2b of the saw blade 2 from the inoperative situation to the operative situation, either at the end of the first step of at the start of the second step or between these two steps. Once the machine has returned to its starting situation (position and states) another cycle can commence.

According to a first embodiment, the carcass is sawn completely in order to produce two independent half carcasses. According to a second embodiment, more especially referred to by the invention, the carcass is sawn only partially, the two sawn carcass parts remaining associated with each other in the region of the spine (American cut), or even at the middle of the back. In this case, the saw blade 2 is moved downwards from its top extreme position as far as a bottom extreme position while keeping a defined bottom extreme part, longer or shorter, of carcass uncut.

According to one embodiment, in the first step, the saw blade 2 is driven in rotation, the protection device 1 being able to be in the non-retracted active situation at the same time as the saw blade 2b pivots, a space existing between both of them, the two not being in contact. Likewise, the protection device 1 can be in the retracted inactive situation at the same time as the saw blade 2b pivots, because of the space in question and the absence of contact between the two of them.

Preferentially, the method comprises a prior step in which a certain prior separation of the hams is ensured. This step is performed manually or in an automated fashion by means suitable for this purpose, in particular an appropriate machine, situated upstream of the machine providing the sawing. One embodiment of a method and machine for sawing a pig carcass is described in the document EP-A-1 125 502 which, to the extent necessary, is incorporated in the present description.

The front part 10 of the casing 4, comprising the casing body 5 and the casing door 6, has the general shape of a narrow pseudoparallelepiped (in the horizontal direction parallel to the direction of movement of the pig carcasses). It is delimited on one side by the external face 11 of the casing body 5 and on the other side by the external face 12 of the casing door 6. It is delimited above by a top edge 13 and below by a bottom edge 14. It is delimited at the front by a front edge 15, slightly inclined from top to bottom and from front to rear, with an angle of around twenty degrees with respect to the vertical. The front edge 15 and the bottom edge 14 are connected by a rounded part 16.

The axis 2a of the saw blade is situated in the vicinity of the rounded part 16. The diameter of the saw blade 2 is such that its sawing cutting edge 2b extends from the top extreme part 17 of the front edge as far as the rear part 18 of the bottom edge 14. Around half of the sawing cutting edge 2b is housed in the casing 4 and around half projects from the casing 4 and can be operative.

The protection device 1 comprises first of all a movable flat piece 19. The movable piece 19 comprises a first protection part 20 and a second support part 21. The first protection part 20 is in the form of a sector of a circular ring. It is able to come to be placed opposite the—or more precisely part of the—sawing cutting edge 2b of the saw blade 2 while protecting it, that is to say while ensuring that it is inoperative. More precisely, the first protection part 20 is placed in the immediate vicinity of the sawing cutting edge 2a and in the plane of the saw blade 2.

The first protection part 20 is distant from the sawing edge 2a by a small radial space so that the saw blade 2 is not prevented from pivoting because of the piece 19 and in particular the protection part 20. The angular opening—or length—of the first protection part 20 is between 45° and 90°, in particular around 60°.

The second support part 21 is in the form of a flange and extends radially. It rigidly supports the first protection part 20. In the embodiment shown, the second support part 21 is in the form of two radii situated one, 20a, at the front end 22 of the first protection part 20 and the other, 20b, in the vicinity of its rear end 23. The second support part 21 is situated in the immediate vicinity of the face opposite the saw blade 2. It is conformed so as to follow this face but without being in contact with it.

The movable piece 19 also comprises a swivel 24, coaxial with the saw blade 2, carried by the casing 4, on which the second support part 21 is mounted opposite to the first protection part 20. The movable piece 19 is arranged so as to be able to tilt about the swivel 24 between two extreme end-of-travel positions, corresponding one to a retracted situation and the other to a non-retracted situation. The swivel 24 and the movable piece 19 are carried by the internal face 25 of the casing door 6. This casing door 6 can be closed and kept positively closed on the casing body 5 by removable closure means 26, in particular during operation. For its part, the saw blade 2 is carried by the internal face 8 of the casing body 5.

The protection device 1 comprises a space 27, formed in the saw head 3, able to receive the movable piece 19 in the retracted situation so that it is then substantially situated in this space 19. The space 27 is produced between the body of the casing 5 provided with the saw blade 2 and the internal face 25 of the casing door 6. The space 27 is provided with a slot 28 for passage of the movable piece 19, situated on the front edge 15. The slot 28 is delimited on one side by the body of the casing 5 and on the other side by the casing door 6. In the active non-retracted situation, the movable piece 19 is substantially situated outside the space 27.

The protection device 1 also comprises means 29 of axial guidance of the movable piece 19. These axial guidance means 29 are in the form of two shoes 29a, 29b, fixed respectively to the body of the casing 5 and to the casing door 6 towards the front end part of the top edge 13 and the top end part 17 of the front edge 15. The axial guidance means 29 guide the first protection part 20 of the movable piece 19, which slides, during its tilting movement, on the free faces of the shoes 29a, 29b situated on each side.

The removable closure means 26 of the casing door 6 are mounted on the guide shoes 29a, 29b. This may be a screw screwed in the shoe associated with the casing door 6 gripping a lug fixed to the shoe associated with the casing body 5.

In a first embodiment, the protection device 1 also comprises means 30 of manoeuvring the movable piece 19 controlled by control means, in order to make the movable piece 19 pass from its retracted inactive situation to its non-retracted active situation, and vice versa, when so desired. The manoeuvring means 30 are a cylinder mounted between the casing 4—and more particular the internal face 25 of the casing door 6—and the movable piece 19—and more particularly the radius 20b at an intermediate point between the swivel 24 and the first protection piece 20. The tilting travel of the movable piece 19 between its two extreme positions is around a quarter of a turn.

In the non-retracted active situation, the first protection part 20 of the movable piece 19 makes inoperative the top part and the front part of the sawing cutting edge 2b of the saw blade 2, from the guide shoes 29a, 29b as far as approximately the distal end 31 of the saw blade 2—the most frontal—situated substantially in the horizontal plane of its axis 2a. The protection device 1—and more precisely the movable piece 19—is made to pass from the retracted inactive situation to the non-retracted active situation by tilting about the swivel 24, the axis of which is also the rotation axis 2a of the saw blade 2. This tilting travel is around a quarter of a turn. It is provided by the manoeuvring means 30. Naturally the protection device 1 is controlled so that it is functionally dependent on the movement of the saw head 3 and therefore the corresponding movement of the saw blade 2.

In a second embodiment, not shown, manoeuvring means such as the means 30 that have just been described are not provided. This is because it was found that it was possible to achieve the passage of the movable piece 19 from its retracted inactive situation to its non-retracted active situation, and vice versa, when required, by the set of forces—in particular weight and friction—to which the movable piece 19 is subjected. This is because the friction forces exerted by the carcass on the movable piece 19 during the downward movement of the saw blade 2 can bring the movable piece 19 into the inactive retracted situation, by acting counter to its own weight. Conversely, the weight of the movable piece 19, combined with the acceleration of the carriage supporting the saw head, can bring the movable piece 10 into the active non-retracted situation.

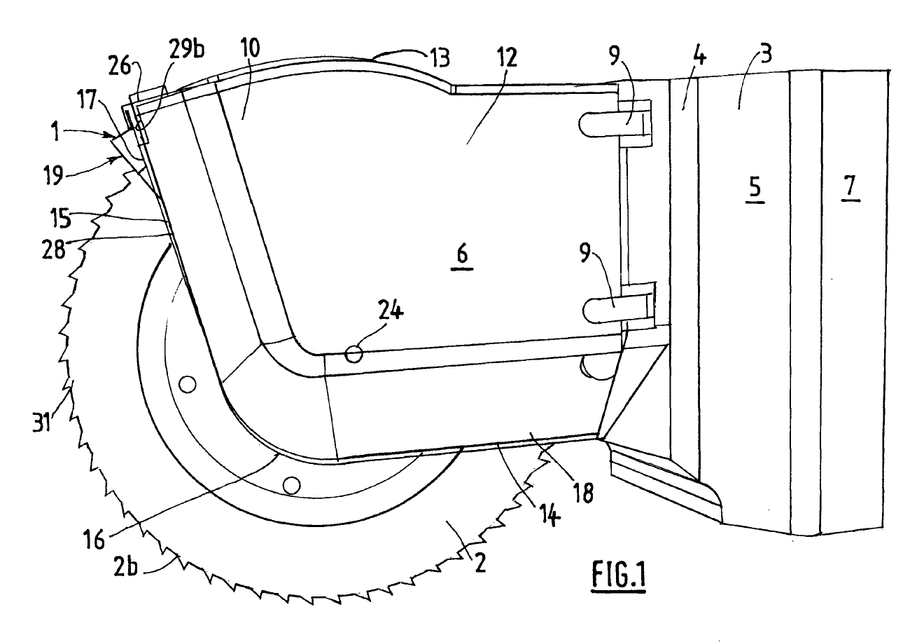

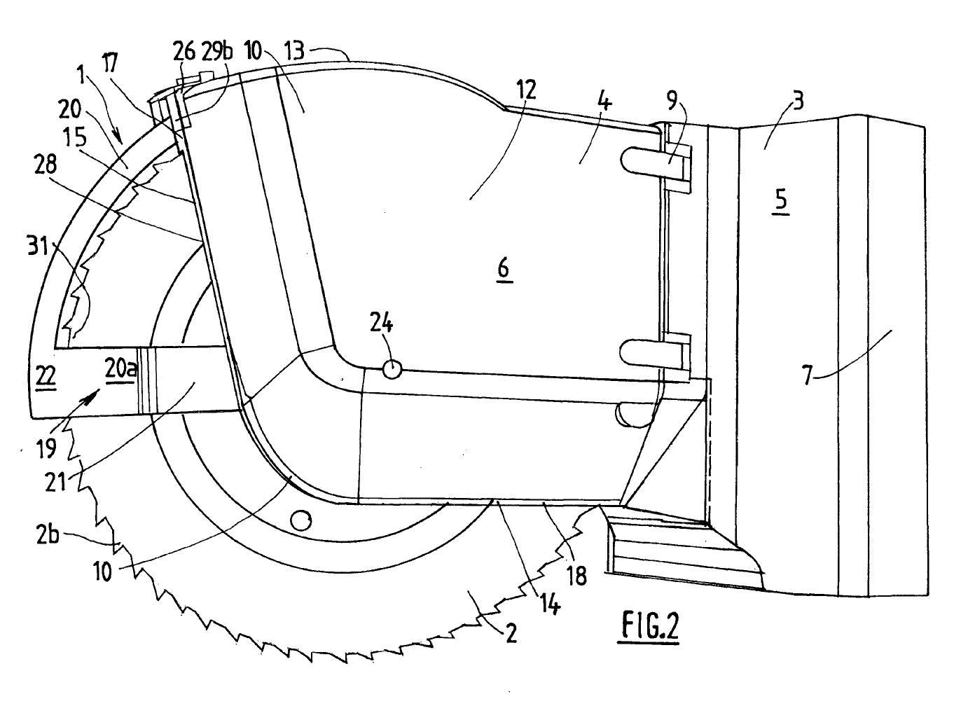

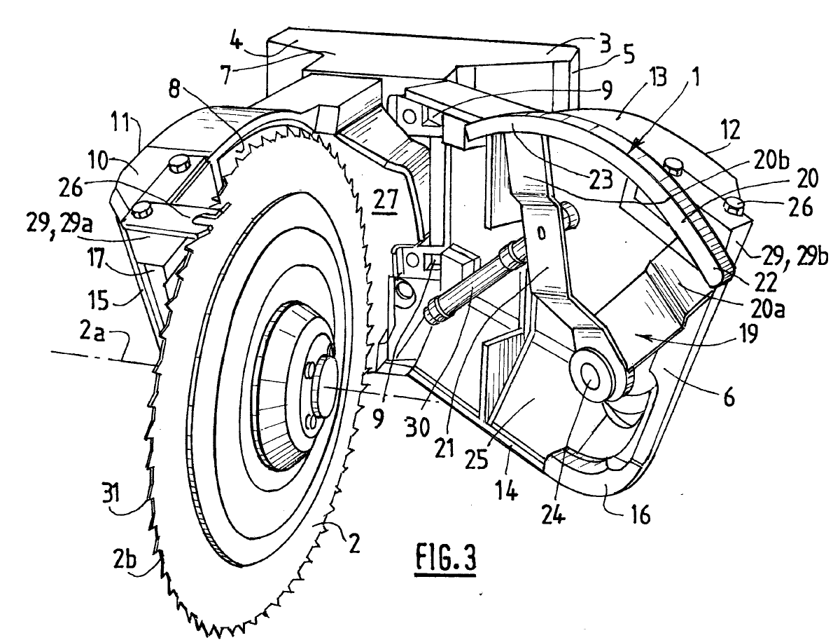

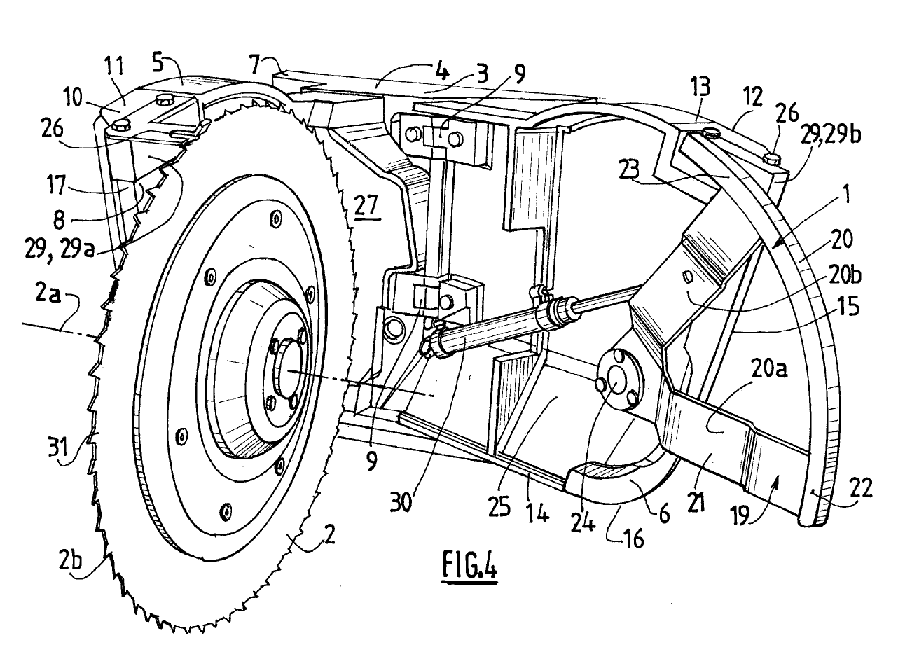

The above description with reference to FIGS. 1 to 4 corresponds to the first embodiment of the protection device 1. In this first embodiment, the protection device 1 is situated on the same side as the saw head 3.

In the second embodiment envisaged, with reference to FIGS. 5 to 7, the protection device 1 is situated not on the same side as the saw head 3 but on the opposite side to it, in particular being carried by or associated with the dorsal support device 36. In this second embodiment, the protection device 1 comprises, firstly, a movable protection piece in the form of a fork 38. This piece has here a roughly cylindrical shape, the rotation axis of which is disposed orthogonally with respect to the movement line of the carcasses C.

The piece 38 has a “housing passage” 39, in the form of a slot, open at the front at its front end 40. This housing passage 39 constitutes a passage and housing for the saw blade 2. The movable piece 38 is therefore able to come to be placed opposite the sawing cutting edge 2b of the saw blade 2, protecting it without preventing the pivoting of the saw blade 2.

The protection device 1 comprises, secondly, means 41 of supporting the movable piece 38, in particular carried by or associated with the dorsal support device 36 of the sawing machine. These support means 41 are for example flat bars situated in parallel vertical planes, taking the piece 38 diametrically on each side.

The protection device 1 comprises, thirdly, means 42 able to make the fork-shaped movable protection piece 38 pass—by sliding and/or tilting—from its inactive situation to its active situation, and vice versa, when required. These means 42 comprises means 43, such as cylinder, rack or gears etc, for manoeuvring the fork-shaped movable piece 38, controlled by external control means, forming part of the control means of the machine, and, where applicable, the manoeuvring pieces 44.

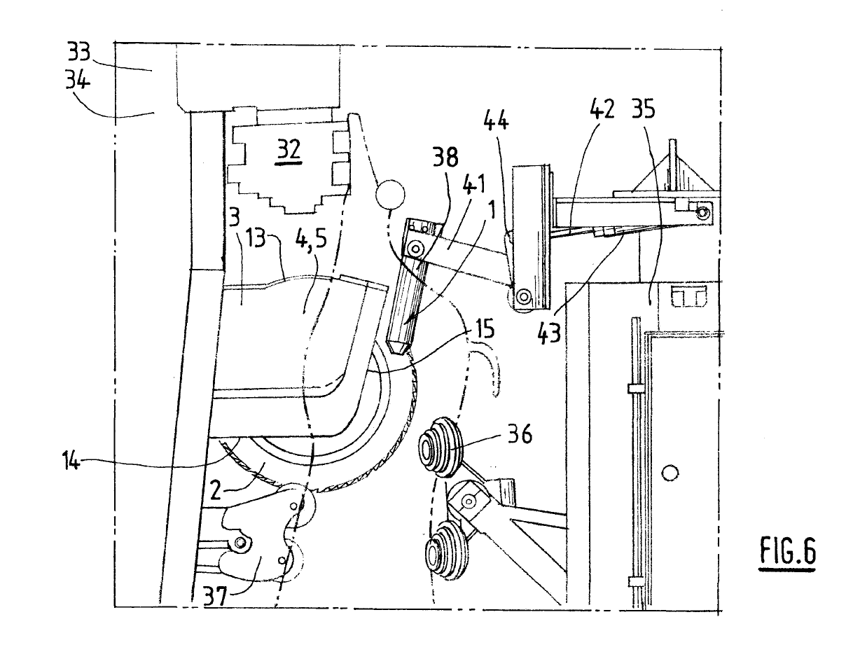

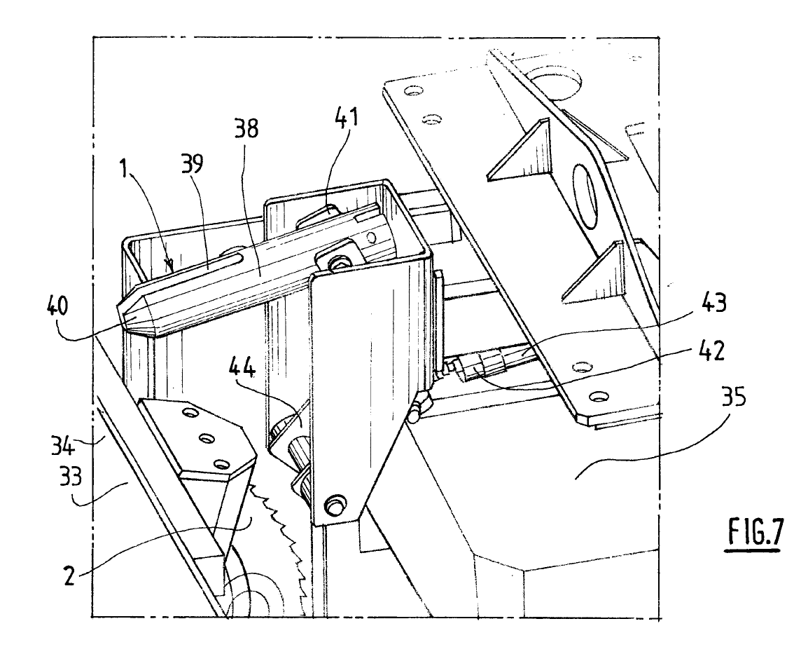

The fork-shaped movable piece 38 comes to be placed on each side of the saw blade 2 above and alongside (dorsal). In the inactive situation (FIGS. 5 and 7), the fork-shaped movable piece 38, which is inclined from top to bottom from the rear, is distant from the saw blade 2. In the active situation (FIG. 6), the fork-shaped movable piece 38, which is further inclined downwards than previously, is placed so that the saw blade 2 passes through the housing passage 39, towards its distal end 31, which suffices to protect the hams of the carcass C from the cutting edge 2b.

The invention claimed is:

1. A method of sawing a pig carcass or the like, the method comprising:
the starting point is a situation where a circular saw blade, carried by a saw head having a casing projecting from it at the front and downwards, is placed opposite and at a distance from the top extreme part—where the hams are situated—of a carcass ready to be sawn, suspended head downwards by the rear legs; and then
in a first step, the saw blade is moved transversely with a respect to, and in the direction of, the carcass and then between the legs;
in a second step, the saw blade being driven in rotation, the relative axial position of the carcass with respect to the saw blade being controlled, the saw blade is moved downwards from its top extreme position as far as a bottom extreme position in order to saw the carcass in two, axially; and
in a third step, the sawing of the carcass being ended, the saw blade is moved transversely with respect to the carcass in order to move it away from it;
wherein in the first step, at the latest before the saw blade interferes with the carcass, the front part of the sawing cutting edge of the saw blade that could interfere with the hams is made inoperative; and
wherein in the second step, the part of the sawing cutting edge of the saw blade driven in rotation that is to saw the carcass is made operative, so as to preserve the integrity of the hams, whilst ensuring effective sawing of the carcass.

2. A method according to claim 1, wherein in the first step also, the saw blade is driven in rotation.

3. A method according to claim 1, further comprising the saw blade is moved downwards from its top extreme position as far as a bottom extreme position while keeping a bottom extreme part of the carcass uncut.

4. A method according to claim 1, further comprising a certain prior separation of the hams is provided.

5. A method according to claim 1, wherein the passage of the sawing cutting edge of the saw blade from the inoperative situation to the operative situation occurs at the end of the first step or at the start of the second step or between the two steps.

6. A method according to claim 1, wherein a movable device for protecting the sawing cutting edge of the saw blade is used, situated with a respect to the latter either in an inactive situation in which it uncovers the active part of the sawing cutting edge of the saw blade that is to provide the sawing of the carcass, thus operative, or in an active situation in which it protects the part of the sawing cutting edge of the saw blade that could interfere with the hams, thus made inoperative in the protected part.

7. A method according to claim 1, wherein the passage of the protection device from the retracted inactive situation to the non-retracted active situation responds either to an external command given for this purpose to the protection device or to the set of forces—in particular weight, friction—to which the protection device is subjected.

8. A method according to claim 1, further comprising a movable protection device situated on the opposite to the saw head, namely typically the dorsal side of the carcass, is used, and the protection device being made to pass from the inactive situation to the active situation, and vice versa, by sliding and/or tilting, the passage from one to the other responding to an external command given for this purpose to the protection device.

9. A carcass-cutting saw blade comprising:
a movable substantially flat piece, having a first protection part in the form of a sector of a circular ring able to come to be placed opposite the sawing cutting edge of the saw blade, protecting it without preventing the pivoting of the saw blade, and a second support part in the form of a flange extending radially and rigidly supporting the first part;
a swivel, coaxial with the saw blade, carried by the casing of the saw head, on which the second part of the movable piece is mounted opposite to the first part, and around which the movable piece can tilt between two extreme end of travel positions corresponding to the retracted inactive situation and to the non-retracted active situation;
a space provided in the saw head, able to receive the movable piece in the retracted inactive situation so that it is then substantially situated in this space, while, in the non-retracted active situation, it is substantially situated outside this space, the said space being provided with a slot for the movable piece to pass; and
moving the movable piece from its retracted inactive situation to its non-retracted active situation, and vice versa, when required.

10. A device according to claim 9, wherein the first part of the movable piece is placed in the immediate vicinity of the sawing cutting edge of the saw blade.

11. A device according to claim 9, wherein the angular opening of the first part of the movable piece is between 45° and 90°.

12. A device according to claim 9, wherein the second part of the movable piece is in the form of radii.

13. A device according to claim 9, wherein the second part of the movable piece is situated in the immediate vicinity of the facing face of the saw blade, but without contact with it.

14. A device according to claim 9, wherein:
the swivel and the movable piece are carried by the internal face of a door of the casing of the saw head, the said door being closed and kept positively closed by a removable closure during operation; and
the saw blade is carried by the body of the casing on which the door is pivotally mounted.

15. A device according to claim 9, wherein the space provided in the saw head is produced between the body of the casing provided with the saw blade and the internal face of the door, the slot of the space being delimited on one side by the body of the casing and on the other side by the door.

16. A device according to claim 9, further comprising means of axial guidance of the movable piece.

17. A device according to claim 9, further comprising shoes, fixed respectively to the body of the casing and to the door, so as to axially guide the first part of the movable piece sliding over the free faces of the shoes, on each side, during its tilting movement.

18. A device according to claim 17, further comprising a removable closure for the door of the casing is mounted on at least one of the guide shoes.

19. A device according to claim 9, further comprising an actuator operably passing the movable piece from its retracted inactive situation to its non-retracted active situation, and vice versa, when required, controlled by an external controller.

20. A device according to claim 19, wherein the actuator includes a fluid-powered cylinder mounted between the casing and the movable piece.

21. A device according to claim 20, wherein the cylinder is mounted on the internal face of the door of the casing.

22. A device according to claim 9, wherein in the non-retracted active situation, the first part of the movable piece makes the top part and front part of the saw blade inoperative, as from the guide shoes, as far as approximately the distal end of the saw blade, situated substantially in the horizontal plane of its axis, that might interfere with hams of the carcass.

23. A device according to claim 9, further comprising using friction and/or weight of the movable piece, without a powered-actuator, to make the movable piece pass from its retracted inactive situation to its non-retracted active situation and vice versa, when required.

24. A device according to claim 9, wherein the tilting travel of the movable piece between its two extreme positions is around a quarter of a turn.

25. A carcass-splitting protection device comprising:
a saw blade having a saw cutting edge;
a substantially fork-shaped movable protection piece comprising a slot for the saw blade, movable relative to the sawing cutting edge of the saw blade, and protecting the saw cutting edge without preventing the pivoting of the saw blade; and
an actuator operably moving the movable protection piece from its inactive situation to its active situation, and vice versa, when required.

26. A device according to claim 25, wherein the movable protection piece is mounted to a back section of the machine on an opposite side of the carcass from the saw blade.

27. A device according to claim 26, further comprising a linkage assembly operably actuated by the actuator, the movable protection piece being moved by the linkage assembly in a substantially transverse direction in-out relative to the carcass and in a substantially vertical, pivoting direction.

28. A device according to claim 25, wherein the slot extends to a distal end of the movable protection piece, the movable protection piece being elongated parallel to the slot, the slot being aligned to receive a portion of the saw blade during at least some of the cutting.

29. A device according to claim 25, wherein an outside surface of the movable protection piece is substantially cylindrical and a leading end adjacent the slot is substantially tapered.

30. A carcass-sawing machine comprising:
a frame;
a circular saw blade, carried by a saw head having a casing, projecting from it at the front and downwards;
a dorsal support device and a ventral support device providing a correct fixed relative positioning of the carcass to be sawn with respect to the saw blade;
a first movable carriage supporting the saw head, a second movable carriage supporting the dorsal support device, and a third movable carriage supporting the ventral support device;
coordinating guidance and driving of the carriages associated with the circular saw blade, the dorsal support device and the ventral support device, in successive sawing cycles;
a controller for the protection device; and
a device operably protecting the saw blade, the protection device being carried by the head of the saw blade, on the same side as it.

31. A machine according to claim 30, wherein the controller for the protection device is part of a controller for the machine itself.

32. A machine for sawing a pig carcass or the like, the machine comprising:
a circular saw blade, carried by a saw head having a casing, projecting from it at the front and downwards;
a dorsal support device and a ventral support device providing a correct fixed relative positioning of the carcass to be sawn with respect to the saw blade; and
a saw blade protector situated on an opposite side of the carcass than the saw head, the protector being carried by or associated with the dorsal support device.

33. The machine according to claim 32, further comprising an overhead conveyor operably supporting and driving the carcass through the machine during the sawing.

34. The machine according to claim 31, further comprising a device operably providing prior separation of the hams before the sawing.

35. The machine according to claim 32, wherein the protector is substantially cylindrical and a leading end adjacent a slot therein is substantially tapered.

36. The machine according to claim 32, wherein the protector includes a slot extending to a distal end thereof, the slot being aligned to receive a portion of the saw blade during at least some of the sawing.

37. The machine according to claim 32, further comprising an actuator and at least one link operably moved in substantially transverse and vertical pivoting directions by the actuator, the protector being coupled to and moved by the at least one link.

38. The machine according to claim 32, wherein the carcass is a pig carcass, and the saw blade and protector horizontally move along the carcass movement plane with the moving carcass during the sawing.
